(19) United States
(12) Patent Application Publication
(10) Pub. No.: US 2003/0093286 A1
(43) Pub. Date: May 15, 2003

(54) Methods and systems for exchanging information, such as information related to supplier activities

(76) Inventors: Wayne T. Myers, Pittsfield, MA (US); Roger Schonewald, Scotia, NY (US); Steve Barbro, Loudonville, NY (US); Herbert F. Butler III, Simpsonville, SC (US); Robert Pitt, Liberty, SC (US); Cyndi Jones, Greer, SC (US); Robin Houseknecht, Albany, NY (US)

Correspondence Address: PERKINS COIE LLP, PATENT-SEA, P.O. BOX 1247, SEATTLE, WA, 98111-1247, US

(21) Appl. No.: 09/997,994

(22) Filed: Nov. 30, 2001

Related U.S. Application Data
(63) Continuation-in-part of application No. 09/991,489, filed on Nov. 15, 2001.

(51) Int. Cl. G06F 17/60

(52) U.S. Cl. 705/1; 705/8

(57) ABSTRACT

Methods and systems for managing supplier activities. In one embodiment, a computer-based system allows a company that contracts with one or more suppliers in a global supplier base to create electronic documents for placing new work packages with those suppliers. These documents can include S.O.W.'s, work schedules, and P.O.'s. In one aspect of this embodiment, the computer-based system allows the company and the respective suppliers to update these documents during performance of the work packages. In one embodiment, the method is initiated on a general-purpose computer by the company who accesses a user interface display page from a server computer to create a new work package document. A supplier can then access the server computer to review the work package document or to update the information contained on the document.

### CROSS-REFERENCE TO RELATED APPLICATION

This application is a continuation-in-part of U.S. patent application No. Ser No. ______, entitled “METHODS AND SYSTEMS FOR EXCHANGING INFORMATION, SUCH AS SUPPLIER PERFORMANCE INFORMATION,” filed Nov. 15, 2001 (Attorney Docket No. 243768073US00) and incorporated herein by reference.

### TECHNICAL FIELD

The following disclosure relates generally to methods and systems for exchanging information related to supplier activities and, more particularly, to computer-implemented methods and systems for managing supplier activities in a global supplier base.

### BACKGROUND

Large engineering enterprises and other companies often rely on outside suppliers to provide certain types of engineering and manufacturing services. These services may involve tasks that require specialized skills or capacities that the offloading companies may lack. Alternatively, these services may involve tasks that require relatively low skills thereby allowing the offloading companies to focus their employees on higher skill work. Offloading work of all types to outside suppliers has become increasingly popular as companies strive to streamline their operations and increase their efficiency. Today, however, competent outside suppliers are spread all over the globe, and are no longer clustered around the traditional economic centers of North America and Europe. While a global supplier base may increase the availability of outside services, it can also complicate management of supplier activities.

Offloading work to outside suppliers involves managing a number of supplier activities. These activities can include the initial step of placing a new work package with a supplier and the subsequent steps of monitoring the supplier during performance of the work package. Placing new work packages with suppliers can require various documents, such as statements of work (S.O.W.'s), work schedules, and purchase orders (P.O.'s). These documents describe the work to be done, the time frame involved, and the expenditures authorized for the work, respectively. These documents are often referred to during the course of a project either for informational purposes or for updating with current status or with revisions to the scope of work.

Current systems for placing new work packages with suppliers have a number of drawbacks. For example, many of these systems utilize S.O.W.'s, work schedules, and P.O.'s that are paper-based and manually controlled. As a result, these systems are not conducive to easy archiving or quick retrieval of work package documentation. Such paper-based systems also make it difficult for suppliers to quickly update the work package documentation because the master documents are often inaccessible to the suppliers. As a result, work package documentation is often inaccurate and not up to date, and changes to work package documentation are often lost. Further, invoices and P.O.'s are often maintained in separate paper-based records, which can result in inaccurate accounting of supplier expenditures. In addition, current systems for placing new work packages are typically unique to the individual business groups that developed them. The documents utilized by these systems, for example, are often tailored to particular suppliers in particular locales, and thus, they do not cover aspects of work packages that may be relevant to other suppliers in other locales. As a result of the individuality of these systems, there is often little uniformity across business groups and few controls to ensure the consistency of documents used to outsource work. Finally, existing systems for creating and updating work package documentation often lack the ability to import legacy data from past work projects to avoid recreating similar documentation.

Current systems for monitoring supplier performance also have a number of drawbacks, especially with a global supplier base. The sophisticated nature of the offloaded work, for example, often makes it difficult to assess supplier performance during an ongoing project. Further, performance often varies from supplier to supplier depending on the volume and complexity of work, the skills of the workforce, and the digital infrastructure that may exist at the supplier's business. In addition, implementation of consistent measuring tools is often frustrated by differences in business systems, languages, and cultures. While some suppliers may have their own performance monitoring systems, these are often unreliable or incompatible with those of the contracting company. The methods and systems disclosed in copending U.S. Patent Application Attorney Docket No. 24376.8073.US00 addresses some of the problems associated with monitoring supplier performance in a global supplier base. This copending U.S. Patent Application is incorporated herein by reference.

As a result of the drawbacks described above, many companies lack efficient systems for placing new work packages with suppliers and monitoring supplier performance. For companies that offload substantial amounts of work to a global supplier base, lacking such systems can significantly increase the cost of managing supplier activities. Therefore, efficient methods and systems are needed for managing these supplier activities.

### BRIEF DESCRIPTION OF DRAWINGS

FIG. 1 is a block diagram illustrating components of a supplier activities management system in one embodiment.

FIG. 2 is a diagram illustrating a display page for requesting an existing work package display page or creating a new work package display page in one embodiment.

FIG. 3 is a diagram illustrating an S.O.W. display page in one embodiment.

FIG. 4 is a diagram illustrating a schedule display page in one embodiment.

FIG. 5 is a diagram illustrating a P.O. display page in one embodiment.

FIG. 6 is a flow diagram illustrating a routine for creating or updating an S.O.W. in one embodiment.

FIG. 7 is a flow diagram illustrating a routine for creating or updating a schedule display page in one embodiment.

FIG. 8 is a diagram illustrating a routine for creating or updating a P.O. display page in one embodiment.

FIG. 9 is a diagram illustrating a process for creating or updating a work package document in one embodiment.

FIG. 10 is a flow diagram illustrating a routine for providing information related to a work package in one embodiment.

### DETAILED DESCRIPTION

Methods and systems are described for managing supplier activities. In one embodiment, a computer-based system allows a company that contracts with one or more suppliers in a global supplier base to create electronic documents for placing new work packages with those suppliers. These documents can include S.O.W.'s, work schedules, and P.O.'s. In one aspect of this embodiment, the computer-based system allows the company and the respective suppliers to update these documents during performance of the work packages. Use of the supplier activities management system in accordance with this disclosure can provide the contracting company with tools for efficient management of its supplier base using consistent documentation, up-to-date performance statuses, and organized data archiving systems.

In one embodiment, the method is implemented on a general-purpose computer, such as a personal computer, by a contracting company (contractor) who accesses one or more user interface display pages from a web site. These display pages can be utilized by the contractor to generate various documents for placing a work package with a supplier. For example, the contractor can generate S.O.W.'s, work schedules, and P.O.'s with the display pages. The contractor enters information onto the display pages describing the respective requirements of the work package. For example, such information can include the objective of the work package, the deliverables included in the work package, and the associated delivery dates. This information is then transmitted over a suitable communications link to a server computer where it is automatically stored in one or more databases. In a further aspect of this embodiment, the supplier is notified, for example, electronically via an email or other electronic messaging system, that the work package documents are available on the web site. The supplier can then access the web site to obtain the work package documents and begin performance of the work package in accordance with the information contained on the documents.

In another embodiment, the supplier can operate a general-purpose computer to access one or more display pages during performance of the work package and update the relevant work package documentation. For example, in one aspect of this embodiment, the supplier can update schedule information on the work schedule display page. The contractor can then access this updated work schedule display page to obtain a current status of the supplier's progress on the work package. Similarly, the supplier can access a P.O. display page during the performance of a work package and update the financial status of the P.O. For example, the supplier can input the dollar value of invoices submitted to the contractor for each component of the P.O. performed.

In yet another embodiment, the supplier activities management system can be used by a domestic-based company, such as a domestic-based manufacturer of power generation equipment and systems, to coordinate work, such as engineering and/or drafting work, to be performed by a foreign supplier. In this embodiment, the domestic-based company can utilize the system to store work package document information in a suitable database. This information can include work scope, schedule, or cost information. The foreign supplier can then utilize the system to access the database and retrieve the information in one or more useable formats. For example, in one embodiment, the information can be formatted as an S.O.W. display page, a schedule display page, or a P.O. display page. In other embodiments, other formats capable of conveying engineering and/or drafting work project information can be used.

The supplier activities management system as described herein offers a number of advantages over conventional systems for work placement. For example, it provides the contractor with up-to-date information on its global supplier base without having to individually contact the various suppliers. The system also provides both contractors and suppliers with easy access to the most current documentation relating to existing contracts. Further, the system provides consistency both in newly generated documents and in archived databases such that individual business groups within a large company do not have to generate and maintain their own boilerplate documentation.

Certain embodiments and methods of the systems described for managing supplier activities are described in the context of computer-executable instructions performed by a general-purpose computer, such as a personal computer. In one embodiment, for example, these computer-executable instructions are stored on a computer-readable medium, such as a floppy disk or CD-ROM. In other embodiments, instructions are stored on a server computer system and accessed via a communications link or computer network, such as an intranet or the Internet. Because the basic structures and functions related to computer-executable routines and corresponding computer implementation systems are well known, they have not been shown or described in detail here to avoid unnecessarily obscuring the described embodiments. Although the following disclosure provides specific details for a thorough understanding of several embodiments of the supplier activities management system, those of ordinary skill in the relevant art will understand that these embodiments may be practiced without some of these details. In other instances, it will be appreciated that the methods and systems described can include additional details without departing from the spirit or scope of the disclosed embodiments.

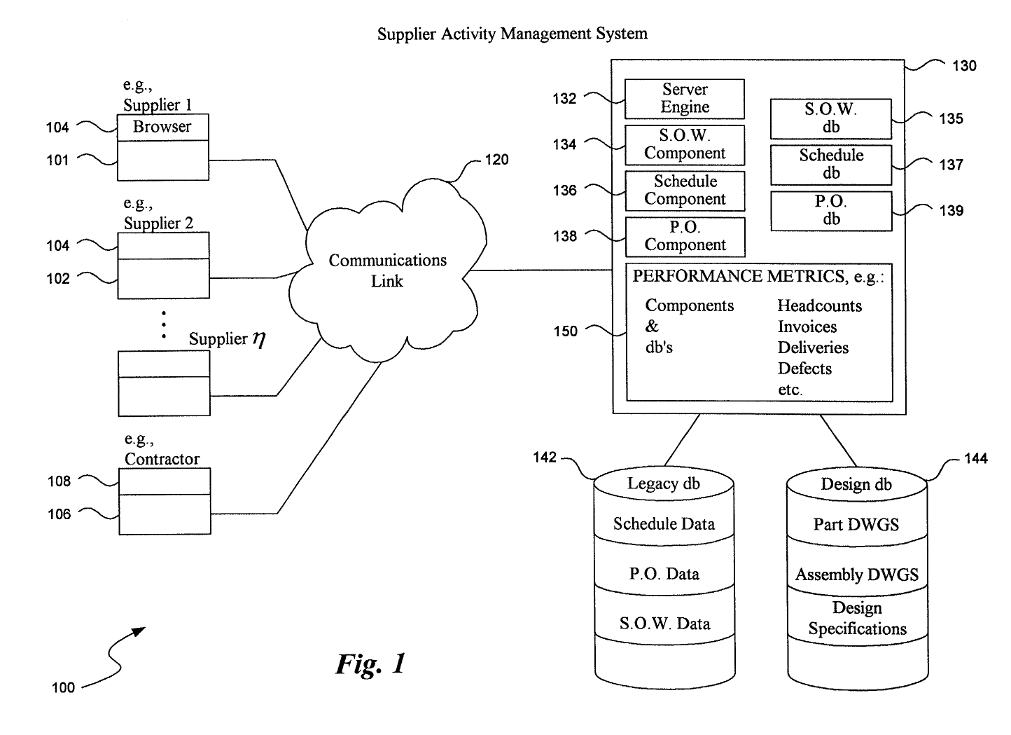

FIG. 1 is a block diagram illustrating components of a supplier activities management system 100 in one embodiment. One or more supplier computers, such as a first supplier computer 101 and a second supplier computer 102, and a contractor computer 106, are connected to a server computer 130 via a communications link 120. In one aspect of this embodiment, the contractor computer 106 may be operated by a company that contracts with suppliers in a global supplier base to manage the activities of the respective suppliers. The one or more supplier computers 101 and 102 may likewise be operated by one or more suppliers to retrieve work package documentation and to update work package information.

In one aspect of this embodiment, the supplier computers 101 and 102, and the contractor computer 106 are general-purpose computers, such as personal computers, and may include a central processing unit, memory devices, input devices (e.g., keyboard and pointing devices), output devices (e.g., display devices), and storage devices (e.g., disk drives). The memory and storage devices are computer-readable media that may contain computer instructions for implementing methods and systems, such as routines and display pages, in accordance with this disclosure. The supplier computers 101 and 102, and the contractor computer 106 may also include a browser module 104 that allows users to access and exchange data with the communications link 120, including web sites within the World Wide Web portion of the Internet. In a further aspect of this embodiment, the communications link 120 is a computer network, such as a local area network (LAN), an intranet, or the Internet.

In one embodiment, the server computer 130 includes a number of facilities for performing aspects of the supplier activities management system 100. For example, the server computer 130 includes a server engine 132, an S.O.W. component 134, a schedule component 136, and a P.O. component 138. The S.O.W. component 134 contains display pages configured to receive statement of work information for a particular work package for generating associated S.O.W. display pages. The schedule component 136 contains display pages configured to receive schedule information for a particular work package for generating associated schedule display pages. Similarly, the P.O. component 138 includes a number of display pages configured to receive purchase order information related to a particular work package for generating associated P.O. display pages.

The server computer 130 of the illustrated embodiment also includes a number of data stores, such as databases, for storing work package data. For example, the server computer 130 includes an S.O.W. database 135 that corresponds to the S.O.W. component 134, a schedule database 137 corresponding to the schedule component 136, and a P.O. database 139 corresponding to the P.O. component 138. In one aspect of this embodiment, the contractor computer 106 can access the components 134, 136 and 138 to generate display pages corresponding to initial work package documentation. Subsequently, a supplier computer 101, such as the first supplier computer 101, can access the generated display pages to obtain information about a particular work package or to update the display pages with project information. After display pages have been created or updated, they can be stored in one of the corresponding databases 135, 137 or 139 on the server computer 130.

The server computer 130 is connected to a legacy database 142 and a design database 144 to retrieve archived data for use in generating supplier activities management display pages. The legacy database 142 contains archived data from past work packages, including S.O.W. data, P.O. data and schedule data. This data can be accessed by one of the corresponding components 134, 136 or 138 if needed when generating new display pages that are based on, or are similar to, past projects. For example, if a work package is substantially similar to an earlier work package placed with a particular supplier, the legacy database 142 can be accessed to provide the relevant data. The design database 144 includes design data that can be linked to S.O.W.'s to provide suppliers with direct access to drawings or specifications that apply to the work packages described by the S.O.W. Archived design data can include part drawings, assembly drawings and design specifications.

The server computer 130 further includes a performance metrics facility 150. In one embodiment, the performance metrics facility 150 contains display page components and databases at least substantially similar to those of the supplier performance monitoring system described in detail in copending Patent Application Attorney Docket No. 24376.8073.US00, incorporated herein by reference.

The various facilities and functionality offered by the server computer 130 in conjunction with the supplier activities management system 100 enables a contractor to generate the documents necessary to place a work package with a supplier. The system further enables a supplier to access these documents to obtain information about the work package or to update the status of the work, which the contractor in turn can then access for informational purposes. As will be apparent to those of ordinary skill in the relevant art, the components and databases described above with reference to the server computer 130 are only representative of those that may be included in the supplier activities management system 100. Accordingly, in other embodiments, more, fewer, or other components and databases can be included to suit the needs of a particular contractor or a particular industry.

Those of ordinary skill in the relevant art will further appreciate that the concepts of the supplier activities management system 100 can be utilized in various environments other than the Internet. For example, the concepts can also be used in electronic mail environments in which the electronic mail messages may include the equivalent of a display page and associated exchanged information. Also, various communications channels other than the Internet may be used, such as a local area network, a wide area network, or a point-to-point dial-up connection. The concepts and attributes of the supplier activities management system 100 may also be used in a single computer environment rather than a client/server environment, such as that depicted in FIG. 1. Accordingly, the supplier activities management system 100 may comprise any combination of hardware or software that can support these concepts. In particular, the server computer 130 may actually include multiple computers. Similarly, a client system, such as the one or more supplier computers 101 and 102 and the contractor computer 106, may comprise any combination of hardware or software that interacts with the server computer 130 in accordance with this disclosure. Such client systems may include television-based systems and various other consumer products through which display pages may be accessed.

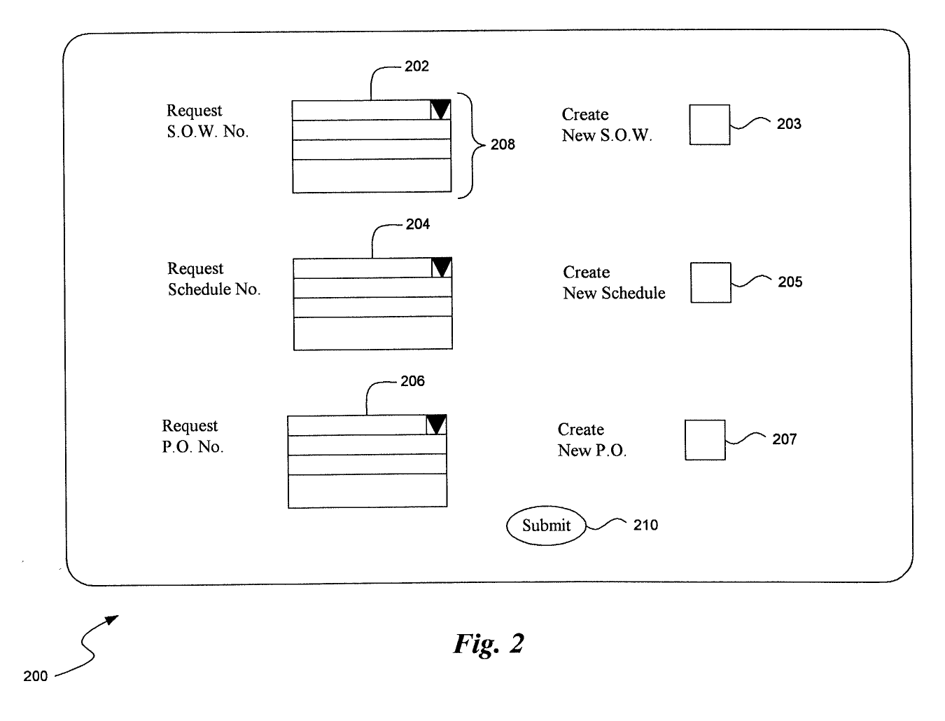

FIG. 2 is a diagram illustrating a display page 200 for requesting a work package display page in one embodiment. The display page 200 can be employed by a user to electronically retrieve an existing work package document or to electronically create a new work package document. In one aspect of this embodiment, the display page 200 includes an S.O.W. field 202, a schedule field 204, and a P.O. field 206. A user may request an existing S.O.W. display page by entering a corresponding S.O.W. identification number in the S.O.W. field 202. Alternatively, the user can select the S.O.W. identification number from an associated drop-down list 208. The requested S.O.W. is automatically retrieved when the user selects a submit button 210. The user may request an existing schedule display page or an existing P.O. display page by entering corresponding identification numbers in the schedule field 204 and the P.O. field 206, respectively, in a similar manner.

In a further aspect of this embodiment, the display page 200 further includes a new S.O.W. box 203, a new schedule box 205, and a new P.O. box 207. If a user desires to create a new S.O.W. display page instead of accessing an existing S.O.W. display page, the user can do so by checking the new S.O.W. box 203 and selecting the submit button 210. Doing so will automatically retrieve a blank S.O.W. display page suitable for generating a new S.O.W. based on user inputs. The user can similarly access a new schedule display page or a new P.O. display page by selecting the new schedule box 205 or the new P.O. box 207, respectively, and selecting the submit button 210 in a similar manner.

In one embodiment, the display page 200 can be accessed via a user computer, such as the contractor computer 106 of FIG. 1, by a user, such as a contractor, who wishes to create new work package documentation. For example, the contractor can use the display page 200 to generate a new S.O.W., a new schedule that corresponds to the S.O.W., and a new P.O. for ordering the work package described in the S.O.W. In another embodiment, the contractor can use the display page 200 to request an existing S.O.W., schedule, or P.O. to obtain an updated status that a user, such as a supplier, may have provided.

In a further embodiment, the display page 200 can be accessed via a user computer, such as the first or second supplier computers 101 or 102 of FIG. 1, by a user, such as a supplier, who wishes to retrieve information about a particular work package or to update information about a work package. For example, the supplier can use the display page 200 to request an existing S.O.W. Alternatively, the supplier can use the display page 200 to request an existing work schedule and then update the work schedule with current project information. The supplier can subsequently save this schedule with the updated information such that the next time this schedule is accessed by a user it will show the updated schedule information.

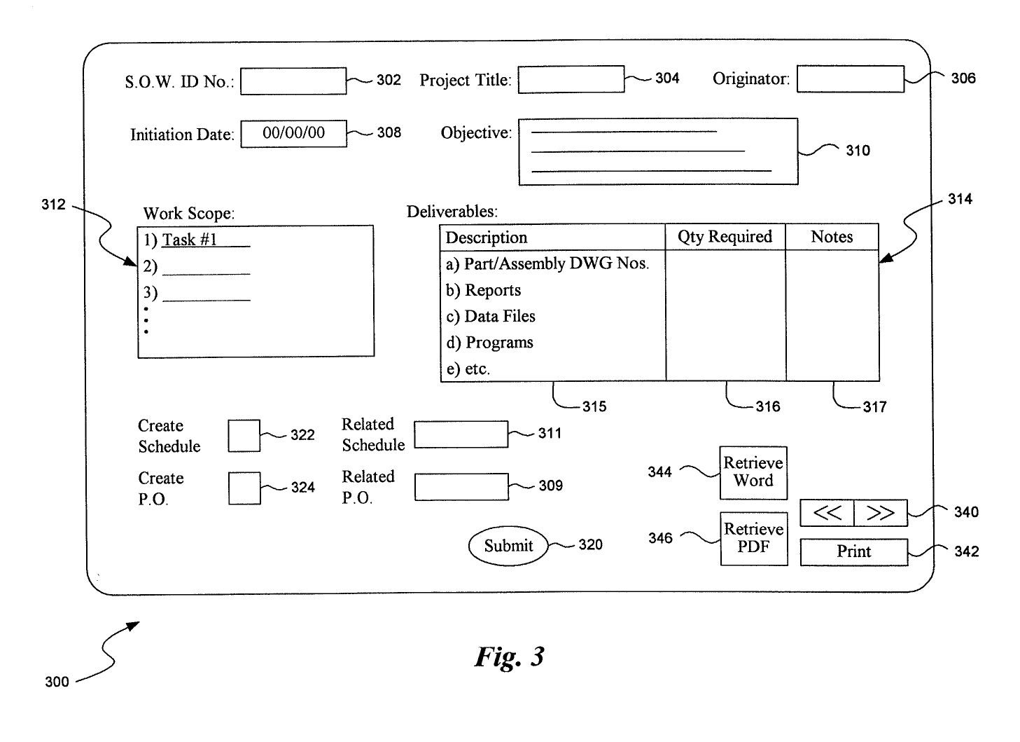

FIG. 3 is a diagram illustrating an S.O.W. display page 300 in one embodiment. In one aspect of this embodiment, the display page 300 can be used by a contractor to generate a new S.O.W. A display page containing the new S.O.W. information can then be accessed by a supplier to obtain information about the corresponding work package. The S.O.W. information accessed by the supplier can include links to related work package documents such as a related schedule field 311 and a related P.O. field 309. The display page 300 includes a number of user input fields configured to receive basic S.O.W. information. For example, the display page 300 includes an S.O.W. identifier field 302, a project title field 304, an originator field 306, and an initiation date field 308. An S.O.W. identification number is automatically generated in the S.O.W. identifier field 302 based on the S.O.W. number input by the user into the S.O.W. field 202 on the display page 200 of FIG. 2. The user may input a project title corresponding to the S.O.W. in the project title field 304. The name of the user and basic contact information for the user can be entered in the originator field 306. A relevant date, such as the date the contracting company and the supplier initiated the S.O.W., can be entered in the initiation date field 308.

The S.O.W. display page 300 further includes an objective box 310, a work scope box 312, and a deliverables box 314. In the objective box 310, the user may enter a brief statement clarifying the purpose of the work package. In the work scope box 312, the user can input concise explanations of the scope of the work to be completed. In one aspect of this embodiment, the work package can be broken down into discrete tasks. For example, these tasks may include analysis tasks, design tasks, manufacturing tasks or documentation tasks. The deliverables box 314 includes a description column 315, a quantity column 316 and a notes column 317. In the description column 315, the user lists each deliverable work product associated with the project. For example, the deliverable work products may include specific mechanical parts or assemblies, reports, data files, computer programs, etc. The user enters the quantities corresponding to each of the deliverables in the quantity column 316, and enters any notes corresponding to the deliverables in the notes column 317.

The S.O.W. display page 300 further includes a submit button 320, a create schedule box 322, a create P.O. box 324, a forward/back selector 340, and a print button 342. Once the user is satisfied that the S.O.W. information entered on the display page 300 is complete and accurate, the user can select the submit button 320 to store the information in a suitable database, such as the S.O.W. database 135 of FIG. 1. Alternatively, the user may “click” in the create schedule box 322 to access a schedule display page for generating a schedule that corresponds to the S.O.W. Similarly, the user can click in the create P.O. box 324 to access a P.O. display page for generating a purchase order that corresponds to the S.O.W. The forward/back selector 340 is provided on the display page 300 should the user desire to jump forward to a next display page (e.g., a schedule or P.O. display page) or back to the previous display page. The user can click the print button 342 to print a hard copy of the created S.O.W.

In addition to the functionalities described above, the display page 300 can also include various links to miscellaneous documents, such as Microsoft Word or PDF documents. For example, the display page 300 includes a retrieve Word link 344 and a retrieve PDF link 346 which, accordingly, link the user to Word and PDF documents, respectively. Portions of these documents can be copied and pasted into the display page 300 to facilitate creation of a corresponding S.O.W.

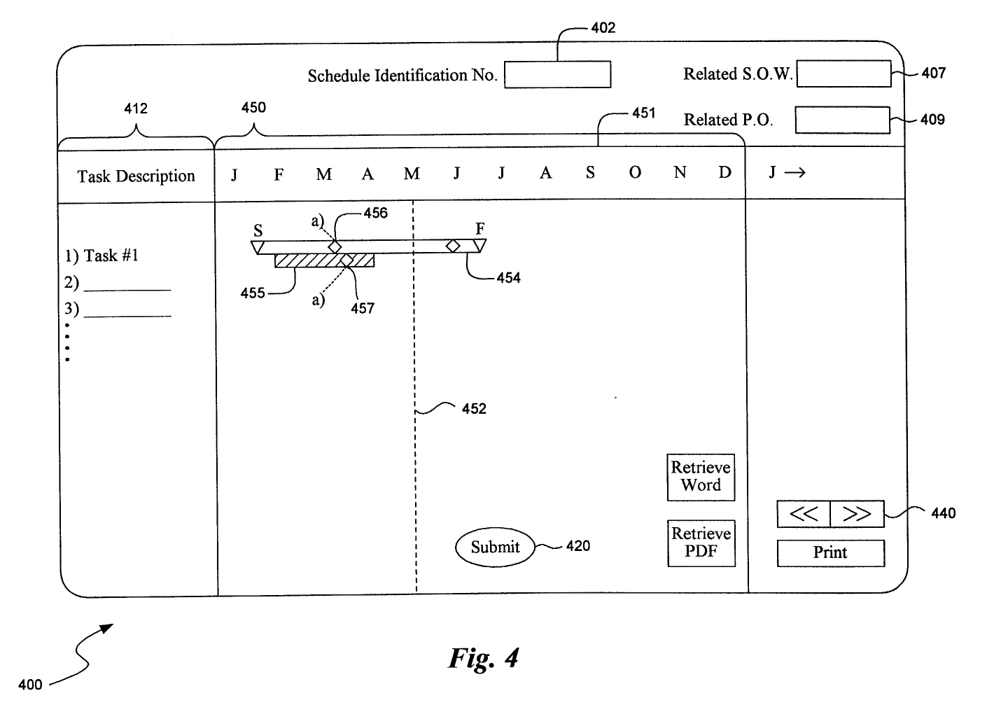

FIG. 4 is a diagram illustrating a schedule display page 400 in one embodiment. The schedule display page 400 can be accessed by a user of the supplier activities management system 100 (FIG. 1) in at least two different embodiments. In the first embodiment, for example, the schedule display page 400 can be accessed via the contractor computer 106 (FIG. 1) by a contractor wishing to create a new schedule corresponding to an S.O.W. In this embodiment, the contractor accesses the schedule display page 400 by checking the new schedule box 205 and clicking the submit button 210 on the display page 200 of FIG. 2. Doing this brings up the schedule display page 400 in “blank” form with a new and previously unused schedule identification number automatically displayed in a schedule identifier field 402.

The schedule display page 400 includes a number of user input fields that the contractor can use to capture work schedule information. For example, the schedule display page 400 includes a task description portion 412 and a task schedule portion 450. The contractor enters concise explanations of each of the work tasks associated with the work project in the task description portion 412. In one aspect of this embodiment, these tasks can correspond to the tasks listed in the work scope box 312 of the display page 300 (FIG. 3). The task schedule portion 450 includes a date bar 451 and a current date line 452. The date bar 451 is divided into fixed time periods, such as years, subdivided into smaller time periods, such as weeks or months. The current date line 452 represents the particular date on which the display page 400 is accessed.

The task schedule portion 450 can include various graphic and textual information to describe the schedule associated with each task listed in the adjacent task description portion 412. For example, in one embodiment, the task schedule portion 450 includes a planned time bar 454 and an actual time bar 455. The planned time bar 454 includes a start date and a finish date defining the time period allotted to the respective task. The actual time bar 455 shows the actual start date of the task and the percentage of the task completed relative to the current date. For example, if the task is being performed on schedule, then the right end of the actual time bar 455 will coincide with the current date line 452. In contrast, if the work is behind schedule, then the right end of the actual time bar 455 will not extend to the current date line 452 (as shown in FIG. 4 for illustration). And accordingly, if the work is ahead of schedule, then the right end of the actual time bar 455 would extend past the current date line 452.

Those of ordinary skill in the relevant art will appreciate that the schedule information captured on the display page 400 can include various other symbology to reflect the different types of tasks and delivery dates. For example, the planned time bar 454 can include one or more milestones 456 that indicate when particular deliverables associated with the tasks are to be delivered by the supplier to the contractor. In one aspect of this embodiment, the deliverable milestones 456 shown on the display page 400 can correspond to the deliverables listed in the deliverables box 314 of FIG. 3. Similarly, the actual time bar 455 can include actual delivery milestones 457 indicating when the respective deliverables were actually delivered to the contractor. When the contractor is satisfied that the schedule information for a particular S.O.W. has been sufficiently entered onto the display page 400, the contractor can click a submit button 420 to store the information in a suitable database, such as the schedule database 137 of FIG. 1. The display page 400 also includes a forward/back selector 440 that enables the user to jump to a previous or next display page. As will be explained in greater detail below, in one embodiment the previous display page is the S.O.W. display page 300 shown in FIG. 3 and the next display page is a P.O. display page.

As stated above, the schedule display page 400 can be accessed by a user of the supplier activities management system 100 (FIG. 1) in at least two different embodiments. In the first embodiment described above, the display page 400 is accessed by a contractor wishing to create a new work project schedule. In a second embodiment, the display page 400 is accessed via a supplier computer, such as the first or second supplier computer 101 or 102 of FIG. 1, by a supplier wishing to view the display page in completed form. In this embodiment, the schedule information corresponding to the display page 400 is retrieved from a database, such as the schedule database 137 of FIG. 1, by the supplier who enters the corresponding schedule identification number in the schedule request field 204 and clicks the submit button 210 on the display page 200 of FIG. 2. In this embodiment, only contractors will be able to create new schedules, while both contractors and suppliers will be able to access existing schedules to obtain schedule information or to update schedules. For example, with reference to the display page 400, only the contractor will be able to create the initial schedule (e.g., the planned time bar 454 and milestone 456), but both the supplier and the contractor will be able to access the display page 400 and update the schedule information, such as the actual time bar 455 and the actual milestone 457. In a further aspect of this embodiment, the completed form of the display page 400 accessed by the supplier can include a related S.O.W. field 407 and a related P.O. field 409. These fields provide the supplier with the corresponding numbers of related work package documents. These fields serve as direct links to the documents, which can be accessed by “doubleclicking” on the fields corresponding to the desired document.

Those of ordinary skill in the relevant art will understand that the schedule functionalities described above with reference to the display page 400 are only representative embodiments. Various other types of schedule functionality can be included in the display page 400 in accordance with this disclosure. Indeed, in other embodiments, it is expected that existing proprietary software packages, such as Microsoft Project, could be employed to generate portions of the schedule display page 400.

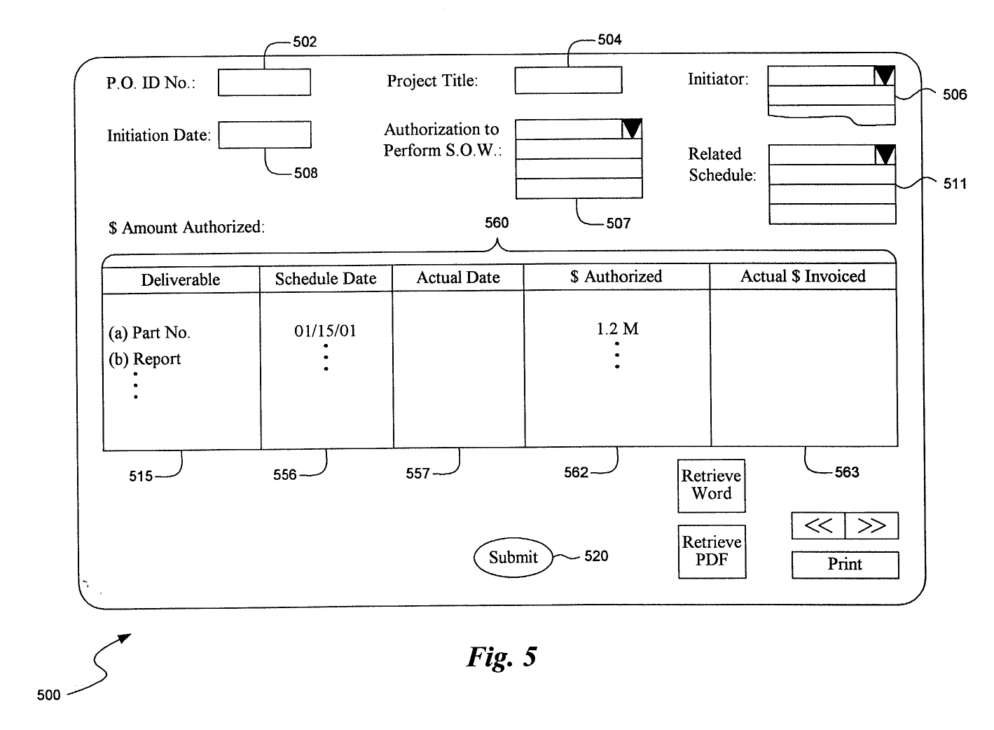

FIG. 5 is a diagram illustrating a P.O. display page 500 in one embodiment. In one aspect of this embodiment, only contractors using the supplier activities management system 100 (FIG. 1) will be able to access the display page 500 to create a new P.O. In contrast, both contractors and suppliers will be able to access existing P.O.'s to obtain P.O. information or to update P.O.'s. In this embodiment, a contractor who wishes to create a new P.O. selects the new P.O. box 207 and clicks the submit button 210 on the display page 200 of FIG. 2. Doing this causes the display page 500 to be automatically displayed on the contractor computer in a blank form with a new P.O. identification number automatically generated in a P.O. identifier field 502.

Much of the information associated with the display page 500 is input by the contractor into respective fields. For example, the display page 500 of the illustrated embodiment includes a project title field 504, a P.O. initiator field 506, an initiation date field 508, a corresponding S.O.W. field 507 and a corresponding related schedule field 511. The contractor may enter an appropriate title for the corresponding project in the project title field 504. A point of contact at the contracting company for the P.O., such as a contracting officer, can be identified in the P.O. initiator field 506. In one aspect of this embodiment, a drop-down list can be provided in connection with this field providing names from which to select. The date the P.O. is formally authorized can be entered in the initiation date field 508, and the S.O.W. that corresponds to the P.O. can be identified in the S.O.W. field 507. An associated drop-down list can be provided in connection with this field providing a list of possible S.O.W. numbers from which to select. Similarly, the schedule or schedules that correspond to the P.O. can be identified in the related schedule field 511.

The display page 500 further includes an expenditure portion 560 that includes a deliverables column 515, a schedule date column 556, an actual date column 557, an authorized expenditure column 562, and an actual expenditure column 563. The contractor enters the deliverables associated with the P.O. in the deliverables column 515. In one aspect of this embodiment, the deliverables listed in this column can be automatically generated based on the deliverables listed in the deliverables box 314 of FIG. 3 when an S.O.W. number is provided in the S.O.W. field 507. The contractor adds scheduled delivery dates corresponding to each of the deliverables in the adjacent schedule date column 556. In a further aspect of this embodiment, the scheduled delivery dates can be automatically generated in the schedule date column 556 based on the delivery milestones, such as the milestone 456, shown on the display page 400 of FIG. 4. The contractor enters the expenditure authorized for each of the respective deliverables in the authorized expenditure column 562. When the contractor is satisfied that the information entered on the display page 500 is sufficient, the contractor clicks a submit button 520 to store this information to a suitable database, such as the P.O. database 139 of FIG. 1.

In one aspect of this embodiment as mentioned above, after the information contained on the display page 500 has been stored in the database, a supplier can retrieve the information during the corresponding work project to update the P.O. with actual data. For example, the supplier can access the display page 500 to enter actual delivery date data into the actual date column 557 for each of the respective deliverables. Similarly, the supplier can update the P.O. by entering actual invoice amounts for each of the respective deliverables in the actual expenditure column 563.

Those of ordinary skill in the relevant art will appreciate that the P.O. facilities and functionalities described above in accordance with FIG. 5 are representative embodiments. Accordingly, various other P.O. functionalities can be included in the display page 500 consistent with this disclosure. For example, the display page 500 in another embodiment might include total invoices paid to a particular supplier for multiple S.O.W.'s.

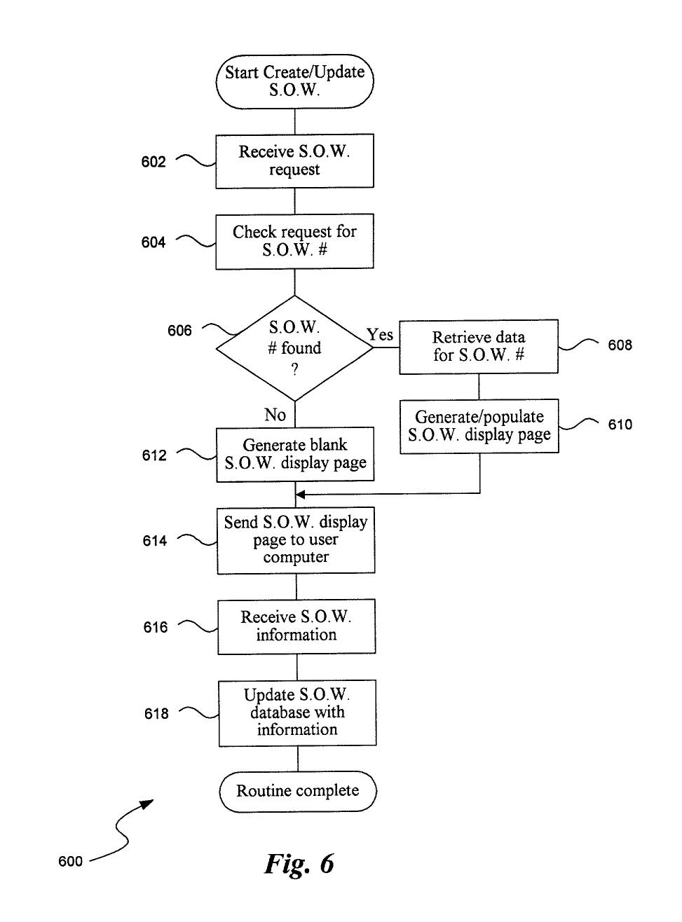

FIG. 6 is a flow diagram illustrating a routine 600 for creating or updating an S.O.W. display page in one embodiment. In one aspect of this embodiment, the routine can be executed on a general-purpose computer, such as the server computer 130 of FIG. 1, in accordance with computer-readable instructions stored on a computer-readable medium, such as a CD-ROM. In block 602, the routine receives an S.O.W. request from a user computer. In block 604, the routine checks the request for a user-entered S.O.W. number. In decision block 606, if an S.O.W. number is found, then in block 608, the routine retrieves data corresponding to this S.O.W. number from a database. In block 610, the routine generates a populated S.O.W. display page using the retrieved data. Returning to decision block 606, if an S.O.W. number is not found in the S.O.W. request, then in block 612, the routine generates a blank S.O.W. display page.

In block 614, the routine sends the generated S.O.W. display page (i.e., either the blank display page or the populated display page) to the user computer that submitted the S.O.W. request. If a user (e.g., a contractor) receives the blank S.O.W. display page, then the user can enter S.O.W. information for a particular work project to generate a new S.O.W. If a user (e.g., a supplier or a contractor) receives a populated S.O.W. display page containing existing S.O.W. data, then the user can review the data for informational purposes or update the display page with actual data. Accordingly, if the user updates the display page, then in block 616, the routine receives S.O.W. update information from the user computer. In block 618, the routine updates the S.O.W. database with the received information, and the routine is complete.

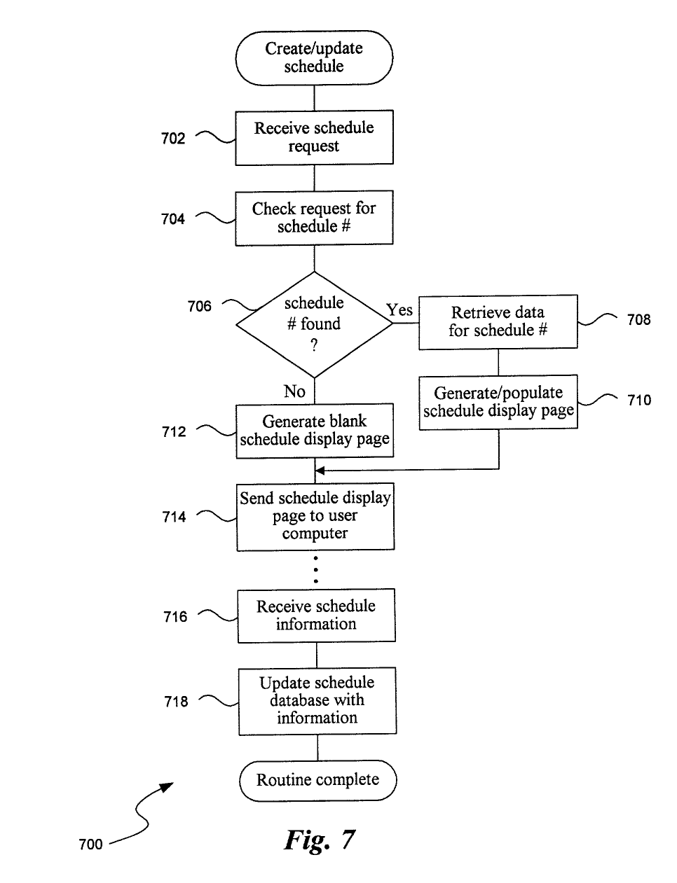

FIG. 7 is a flow diagram illustrating a routine 700 for creating or updating a schedule display page in one embodiment. In one aspect of this embodiment, the routine can be executed on the server computer 130 of FIG. 1 in accordance with computer-readable instructions stored on a computer-readable medium, such as a CD-ROM. In block 702, the routine receives a schedule request. In one embodiment, the received schedule request can be a request from a supplier computer, such as the supplier computer 101 or 102 of FIG. 1, for existing schedule data related to a particular work project. In another embodiment, the received schedule request may come from a contractor computer, such as the contractor computer 106 of FIG. 1, requesting a blank schedule display page so that a contractor can create a new schedule for a new work project.

In block 704, the routine checks the received request for a user-entered schedule number. In decision block 706, if a schedule number is found, then in block 708, the routine retrieves data corresponding to the schedule number from one or more databases. In block 710, the routine generates a populated schedule display page using the retrieved data. Returning to decision block 706, if a schedule number is not found in the received request, then in block 712, the routine generates a blank schedule display page. In block 714, the routine sends the schedule display page (i.e., either the blank schedule display page or the populated schedule display page) to the user computer that submitted the request.

The schedule display page sent in block 714 can be used in at least two different embodiments in accordance with this disclosure. For example, if the blank schedule display page is received and displayed on a contractor computer, such as the contractor computer 106 of FIG. 1, then the contractor can utilize the blank display page to create a new work schedule. In contrast, if the populated schedule display page is received and displayed on a supplier computer, such as the supplier computer 101 or 102 of FIG. 1, then the supplier can view the schedule information and/or update the schedule with actual data. The supplier does not have the option of creating a new schedule or altering any of the planned schedule dates. The contractor may also update existing schedules by adding actual milestone dates to populated schedule display pages. In accordance with these different embodiments, in block 716, the routine receives schedule information. This schedule information might be new information from a contractor to create a new schedule or actual information provided by a supplier to update an existing schedule. In block 718, the routine updates the schedule database with the received schedule information, and the routine is complete.

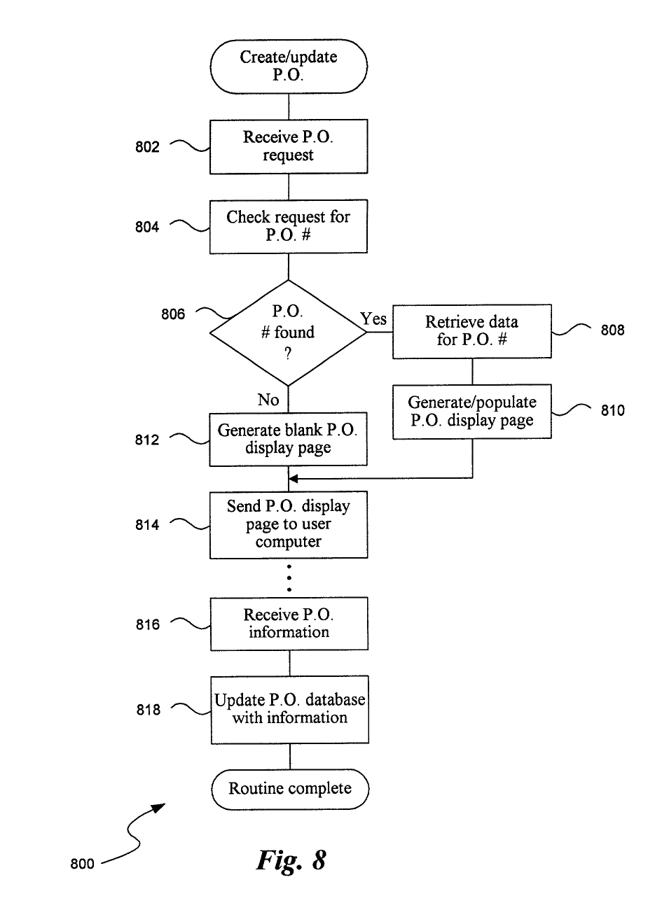

FIG. 8 is a diagram illustrating a routine 800 for creating or updating a P.O. display page in one embodiment. In block 802, the routine receives a P.O. request. In block 804, the routine checks the received request for a P.O. number. In decision block 806, if a P.O. number is found, then in block 808, the routine retrieves data corresponding to the P.O. number from one or more databases. In block 810, the routine generates a populated P.O. display page containing the retrieved P.O. data. Returning to decision block 806, if a P.O. number is not found, then in block 812, the routine generates a blank P.O. display page. In block 814, the generated P.O. display page (i.e., either the blank P.O. display page for creating a new P.O. or the populated P.O. display page containing existing information for a particular P.O.) is sent to the user computer that submitted the P.O. request. In block 816, the routine receives P.O. information from the user computer. As discussed above, in one embodiment, this P.O. information can be new P.O. information for generating a new P.O., and in another embodiment, this information can be actual P.O. information, such as invoice data, for updating an existing P.O. In block 818, the received P.O. information is stored in a suitable database, and the routine is complete.

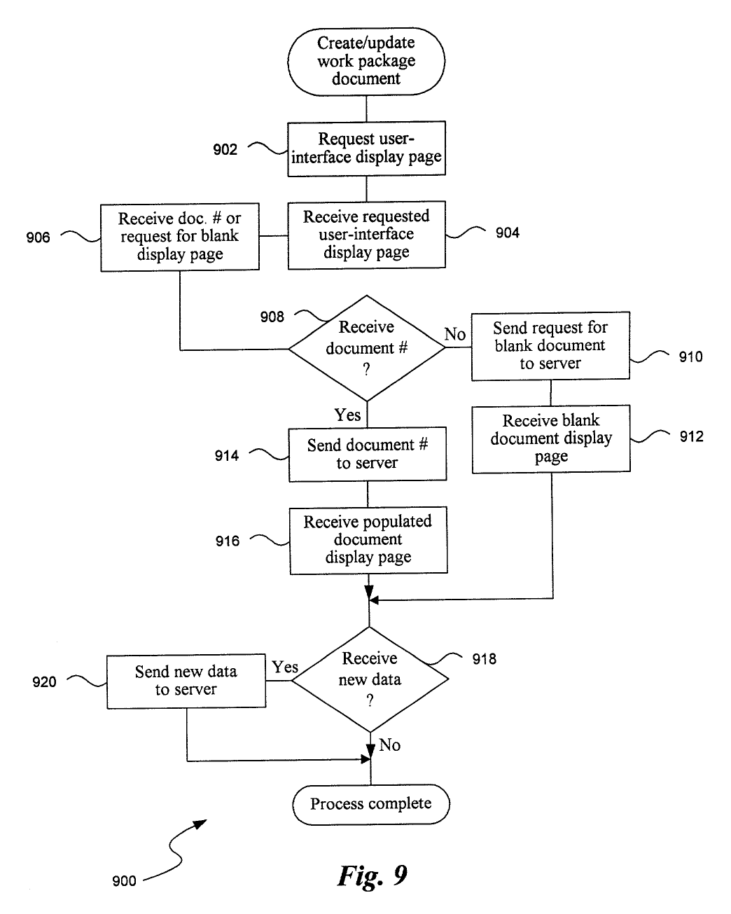

FIG. 9 is a diagram illustrating a process 900 for creating or updating a work package document in one embodiment. In one aspect of this embodiment, the term “work package document” as used herein refers to one or more documents used to coordinate work projects such as an S.O.W., a work schedule, or a P.O. In a further aspect of this embodiment, the process 900 is executed via a browser module operating on a user computer, such as one of the supplier computers 101 or 102, or the contractor computer 106, of FIG. 1.

In block 902, the user computer sends a request for a user interface display page to a server computer, such as the server computer 130 of FIG. 1, in response to an input or selection from a user. In block 904, the user computer receives the requested user interface display page from the server computer. In this embodiment, the requested user interface display page is configured to receive user input comprising either a number corresponding to an existing work package document or a request to create a new work package document. Accordingly, in block 906, the user computer receives either a document number or a request for a blank display page from the user.

In decision block 908, if the user computer receives a document number, then in block 914, it sends this document number to the server computer. In block 916, the user computer receives a populated display page containing information corresponding to the document number sent to the server computer. Returning to decision block 908, if the user computer does not receive a document number, then in block 910, the user computer sends a request for a blank display page to the server computer. In one aspect of this embodiment, the requested blank display page corresponds to a particular type of work package document the user wishes to create. In block 912, the user computer receives the requested blank display page.

In one embodiment, if the user computer receives a populated display page, then the user may update the information contained on the display page. Conversely, the user may elect to only view the data displayed on the populated display page. In another embodiment, if the user computer receives a blank display page, then the user can input new work package information on the display page to create a new work package document. Accordingly, in decision block 918, the user computer may receive either update information or new work package information. In decision block 918, if the user computer receives either type of new information, then in block 920, the user computer sends this new information to the server computer for storage in one or more databases, and the process 900 is complete. If no new data is received by the user computer, then the process 900 completes after presenting the received display page to the user.

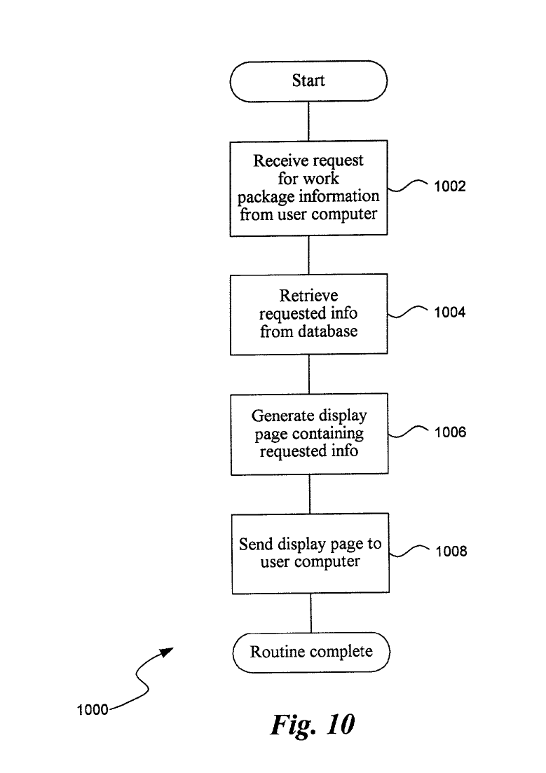

FIG. 10 is a flow diagram illustrating a routine 1000 for providing information related to a work package in one embodiment. In one aspect of this embodiment, the routine can be implemented on a server computer, such as the server computer 130 of FIG. 1, in accordance with computer-readable instructions stored on a computer-readable medium, such as a CD-ROM. In a further aspect of this embodiment, the routine can be executed, for example, in response to a received request from a user computer, such as the supplier computer 101 or 102, or the contractor computer 106, of FIG. 1.

In block 1002, the routine receives a request from a user computer for information related to a particular work package. In one embodiment, this information is related to a work package document, such as an S.O.W., a work schedule, or a P.O. In block 1004, the routine searches for the requested information in one or more databases and retrieves the information. In block 1006, the routine generates a display page containing the requested work package information. In block 1008, the routine sends the display page containing the requested information to the user computer that submitted the request, and the routine is complete.

It will be appreciated from the foregoing that although specific embodiments of the supplier activities management system of FIG. 1 have been described for purposes of illustration, various modifications may be made without departing from the spirit or scope of the invention. Further, although the methods and systems have been described in the context of suppliers of engineering or drafting services, it will be understood by those of ordinary skill in the relevant art that the methods and systems disclosed here are equally well suited for other types of suppliers in other types of industries. Those of ordinary skill in the relevant art will additionally appreciate that these and other changes may be made to the invention in light of the above detailed description.

While certain aspects of the invention are presented below in certain claim forms, the inventors nevertheless contemplate additional embodiments of the invention consistent with other claim forms. Accordingly, the inventors reserve the right to add additional claims after filing the application to pursue such additional claim forms for all aspects of the invention as contemplated. Further, the terms used in the following claims should not be construed to limit the invention to the specific embodiments disclosed in the specification or claims, but instead, should be construed to include all supplier activities management systems that operate in accordance with the claims. The scope of the invention is therefore not limited by this disclosure, but, instead, the scope of the invention is to be determined entirely by the following claims.

We claim:

1. A method in a computer system for providing information related to work package documentation, the work package documentation defining aspects of goods and/or services provided by a supplier for a contractor, the method comprising:
receiving a first request for a first user interface display page from a contractor computer;
in response to the received first request, providing the first user interface display page to the contractor computer, the first user interface display page being configured to receive information related to a work package document;
receiving the work package document information from the contractor computer;
storing the received work package document information in a database;
receiving a second request for a second display page from a supplier computer; and
in response to the received second request,
retrieving at least a first portion of the stored work package document information from the database;
generating the second display page, the second display page containing at least a second portion of the retrieved work package document information; and
providing the second display page to the supplier computer.

2. The method of claim 1 wherein the work package document is a statement of work.

3. The method of claim 1 wherein the work package document is a work schedule.

4. The method of claim 1 wherein the work package document is a purchase order.

5. The method of claim 1 wherein the first user interface display page is configured to receive first information related to the work package document and the second display page is a second user interface display page configured to receive second information related to the work package document, the method further comprising:
receiving the second work package document information from the supplier computer;
storing the received second work package document information in the database;
receiving a third request for a third display page from the contractor computer; and
in response to the received third request,
retrieving at least a third portion of the stored second work package document information from the database;
generating the third display page, the third display page containing at least a fourth portion of the retrieved second work package document information; and
providing the third display page to the contractor computer.

6. The method of claim 5 wherein:
the work package document is a work schedule;
the second work package document information received from the supplier computer is work schedule update information; and
the third display page provided to the contractor computer contains at least a portion of the work schedule update information.

7. The method of claim 5 wherein:
the work package document is a work schedule;
the first work package document information received from the contractor computer includes planned schedule dates;
the second work package document information received from the supplier computer includes actual schedule dates; and
the third display page provided to the contractor computer contains at least a portion of the actual schedule dates received from the supplier computer.

8. The method of claim 5 wherein:
the work package document is a purchase order;
the second work package document information received from the supplier computer is purchase order update information; and
the third display page provided to the contractor computer contains at least a portion of the purchase order update information.

9. The method of claim 5 wherein:
the work package document is a purchase order;
the first work package document information received from the contractor computer includes planned expenditures;
the second work package document information received from the supplier computer includes actual expenditures; and
the third display page provided to the contractor computer contains at least a portion of the actual expenditures received from the supplier computer.

10. A method in a computer system for providing information related to a work project, the method comprising:
receiving a first request for a first user interface display page from a first computer;
in response to the received first request, providing the first user interface display page to the first computer, the first user interface display page configured to receive information describing a planned scope, schedule, or cost of the work project;
receiving the scope, schedule, or cost information from the first user computer;
storing the received scope, schedule, or cost information in a database;
receiving a second request for a second display page from a second computer; and
in response to the received second request,
retrieving at least a first portion of the stored scope, schedule, or cost information from the database;
generating the second display page, the second display page containing at least a second portion of the retrieved scope, schedule, or cost information; and
providing the second display page to the second computer.

11. The method of claim 10 wherein the first user interface display page is configured to receive information including:
a project title;
a project start date; and
at least one project deliverable, the at least one project deliverable being a discrete work product to be provided as part of the work project.

12. The method of claim 10 wherein the second display page is a second user interface display page configured to receive second information related to the scope, schedule, or cost of the work project, the method further comprising:
receiving the second scope, schedule, or cost information from the second computer;
storing the received second scope, schedule, or cost information in the database;
receiving a third request for a third display page from the first computer;
in response to the received third request,
retrieving at least a third portion of the stored second scope, schedule, or cost information from the database; and
generating the third display page, the third display page containing at least a fourth portion of the retrieved second scope, schedule, or cost information; and
providing the third display page to the first computer.

13. The method of claim 12 wherein:
the second scope, schedule, or cost information received from the second computer includes actual information; and
the third display page provided to the first computer contains at least a portion of the actual information received from the second computer.

14. A method in a computer system for providing information related to a work project to a server computer, the method comprising:
requesting a user interface display page from the server computer;
in response to the request, receiving the user interface display page from the server computer, the user interface display page configured to receive information describing a planned scope, schedule, or cost of the work project;
receiving the planned scope, schedule, or cost information; and
transmitting the received planned scope, schedule, or cost information to the server computer.

15. The method of claim 14 wherein the user interface display page is configured to receive information including:
a project title;
a project start date; and
at least one project deliverable, the at least one project deliverable being a discrete work product to be provided as part of the work project.

16. The method of claim 14 wherein the user interface display page is configured to receive information including:
a project title;
at least one project deliverable, the at least one project deliverable being a discrete work product to be provided as part of the work project; and
at least one planned milestone, the at least one planned milestone representing a date related to the delivery of the at least one project deliverable.

17. The method of claim 14 wherein the user interface display page is configured to receive information including:
a project title;
at least one project deliverable, the at least one project deliverable being a discrete work product to be provided as part of the work project; and
at least one planned expenditure, the at least one planned expenditure relating to a cost of the at least one project deliverable.

18. The method of claim 14 wherein the user interface display page is a first user interface display page, the method further comprising:
requesting a second user interface display page from the server computer;
in response to the request, receiving the second user interface display page from the server computer, the second user interface display page configured to receive information describing an actual scope, schedule, or cost of the work project;
receiving the actual scope, schedule, or cost information; and
transmitting the received actual scope, schedule, or cost information to the server computer.

19. The method of claim 18 wherein:
the first user interface display page is configured to receive information including:
at least one project deliverable, the at least one project deliverable being a discrete work product to be provided as part of the work project; and
at least one planned milestone, the at least one planned milestone representing a date related to the delivery of the at least one project deliverable; and
the second user interface display page is configured to receive information including:
at least one actual milestone, the at least one actual milestone representing a date related to the actual delivery of the at least one project deliverable.

20. The method of claim 18 wherein:
the first user interface display page is configured to receive information including:
at least one project deliverable, the at least one project deliverable being a discrete work product to be provided as part of the work project; and
at least one planned expenditure, the at least one planned expenditure relating to a planned cost of the at least one project deliverable; and
the second user interface display page is configured to receive information including:
at least one actual expenditure, the at least one actual expenditure relating to an actual cost of the at least one project deliverable.

21. The method of claim 18 wherein:
the request for the first user interface display page is sent from a first user computer; and
the request for the second user interface display page is sent from a second user computer different from the first user computer.

22. A computer system for providing information related to a work project, the computer system comprising:
means for receiving a first request for a first user interface display page from a first computer;
means for providing the first user interface display page to the first computer in response to the received first request, the first user interface display page being configured to receive information describing a planned scope, schedule, or cost of the work project;
means for receiving the planned scope, schedule, or cost information from the first user computer;
means for storing the received planned scope, schedule, or cost information in a database;
means for receiving a second request for a second display page from a second computer;
means for retrieving at least a first portion of the stored planned scope, schedule, or cost information from the database in response to the received second request;
means for generating the second display page in response to the received second request, the second display page containing at least a second portion of the retrieved planned scope, schedule, or cost information; and
means for providing the second display page to the second computer in response to the received second request.

23. The computer system of claim 22 wherein the means for providing the first user interface display page includes means for providing the first user interface display page configured to receive information including:
a project title;
a project start date; and
at least one project deliverable, the at least one project deliverable being a discrete work product to be provided as part of the work project.

24. The computer system of claim 22 wherein the means for providing the second display page includes means for providing a second user interface display page configured to receive second information related to the scope, schedule, or cost of the work project, the computer system further comprising:
means for receiving the second scope, schedule, or cost information from the second computer;
means for storing the received second scope, schedule, or cost information in the database;
means for receiving a third request for a third display page from the first computer;
means for retrieving at least a third portion of the stored second scope, schedule, or cost information from the database in response to the received third request;
means for generating the third display page, the third display page containing at least a fourth portion of the retrieved second scope, schedule, or cost information; and
means for providing the third display page to the first computer.

25. The computer system of claim 22 wherein:
the second scope, schedule, or cost information received from the second computer includes actual information; and
the third display page provided to the first computer contains at least a portion of the actual information received from the second computer.

26. A computer-readable medium whose contents cause a computer system to provide information related to work package documentation, the work package documentation defining aspects of goods and/or services provided by a supplier for a contractor, the information being provided by a method comprising:
receiving a first request for a first user interface display page from a contractor computer;
in response to the received first request, providing the first user interface display page to the contractor computer, the first user interface display page being configured to receive information related to a work package document;
receiving the work package document information from the contractor computer;
storing the received work package document information in a database;
receiving a second request for a second display page from a supplier computer; and
in response to the received second request,
retrieving at least a first portion of the stored work package document information from the database;
generating the second display page, the second display page containing at least a second portion of the retrieved work package document information; and
providing the second display page to the supplier computer.

27. The computer-readable medium of claim 26 wherein the work package document is a statement of work.

28. The computer-readable medium of claim 26 wherein the work package document is a work schedule.

29. The computer-readable medium of claim 26 wherein the work package document is a purchase order.

30. The computer-readable medium of claim 26 wherein the first user interface display page is configured to receive first information related to the work package document and the second display page is a second user interface display page configured to receive second information related to the work package document, the method further comprising:
receiving the second work package document information from the supplier computer;
storing the received second work package document information in the database;
receiving a third request for a third display page from the contractor computer; and
in response to the received third request,
retrieving at least a third portion of the stored second work package document information from the database;
generating the third display page, the third display page containing at least a fourth portion of the retrieved second work package document information; and
providing the third display page to the contractor computer.

31. The computer-readable medium of claim 30 wherein:
the work package document is a work schedule;
the second work package document information received from the supplier computer is work schedule update information; and
the third display page provided to the contractor computer contains at least a portion of the work schedule update information.

32. The computer-readable medium of claim 30 wherein:
the work package document is a work schedule;
the first work package document information received from the contractor computer includes planned schedule dates;
the second work package document information received from the supplier computer includes actual schedule dates; and
the third display page provided to the contractor computer contains at least a portion of the actual schedule dates received from the supplier computer.

33. The computer-readable medium of claim 30 wherein:
the work package document is a purchase order;
the second work package document information received from the supplier computer is purchase order update information; and
the third display page provided to the contractor computer contains at least a portion of the purchase order update information.

34. The computer-readable medium of claim 30 wherein:
the work package document is a purchase order;
the first work package document information received from the contractor computer includes planned expenditures;
the second work package document information received from the supplier computer includes actual expenditures; and
the third display page provided to the contractor computer contains at least a portion of the actual expenditures received from the supplier computer.

35. A computer-readable medium containing a display page configured to receive information related to a statement of work, the statement of work describing a work project to be performed by a supplier for a contractor, the display page comprising:
a work scope portion configured to receive one or more task descriptions describing one or more tasks to be performed by the supplier for the contractor as part of the work project;
a deliverables portion configured to receive one or more work product identifiers identifying one or more work products to be delivered by the supplier for the contractor as part of the work project; and
a contact field configured to receive the name of an individual who can be contacted for information related to the statement of work.

36. The computer-readable medium of claim 35 further comprising:
a statement of work identification field configured to display a statement of work identifier identifying the statement of work; and
a date field configured to display a date related to the statement of work.

37. The computer-readable medium of claim 35 further comprising:
a schedule field configured to display a schedule identifier identifying a schedule associated with the statement of work; and
a purchase order field configured to display a purchase order identifier identifying a purchase order associated with the statement of work.

38. The computer-readable medium of claim 35 wherein the deliverables portion is further configured to receive one or more quantities associated with the one or more work products to be delivered by the supplier.

39. A computer-readable medium containing a display page configured to receive information related to a work schedule, the work schedule describing schedule aspects of a work project to be performed by a supplier for a contractor, the display page comprising:
a task description portion configured to receive one or more at least general descriptions of one or more tasks associated with the work project;
a task schedule portion configured to receive one or more timelines corresponding to the one or more tasks received by the task description portion; and
a related statement of work field configured to display a statement of work identifier identifying a statement of work that is associated with the work schedule.

40. The computer-readable medium of claim 39 wherein the display page further comprises:
a related purchase order field configured to display a purchase order identifier identifying a purchase order that is associated with the work schedule.

41. The computer-readable medium of claim 39 wherein the task schedule portion is further configured to receive one or more milestones, the one or more milestones corresponding to delivery dates for one or more work products associated with the one or more tasks received by the task description portion.

42. The computer-readable medium of claim 39 wherein:
the task schedule portion is configured to receive one or more planned timelines and one or more actual timelines corresponding to the one or more tasks received by the task description portion; and
the task schedule portion is further configured to receive one or more planned milestones and one or more actual milestones, the one or more planned milestones corresponding to planned delivery dates for one or more work products associated with the one or more tasks received by the task description portion, the one or more actual milestones corresponding to actual delivery dates for one or more work products associated with the one or more tasks received by the task description portion.

43. A computer-readable medium containing a display page configured to receive information related to a purchase order, the purchase order describing authorized expenditures for a work project to be performed by a supplier for a contractor, the display page comprising:
a least one deliverable field configured to receive a discrete work product to be provided by the supplier for the contractor as part of the work project;
at least one date field configured to receive a date related to the delivery of the at least one deliverable;
at least one authorized amount field configured to receive an a dollar amount related to a purchase price for the at least one deliverable; and
a related statement of work field configured to display a statement of work identifier identifying a statement of work associated with the purchase order.

44. The computer-readable medium of claim 43 further comprising a contact field configured to receive the name of an individual who can be contacted for information related to the purchase order.

45. The computer-readable medium of claim 43 further comprising:
a schedule identification field configured to display a schedule identifier identifying a schedule associated with the purchase order; and
a date field configured to display a date related to the purchase order.

46. A method in a computer system for coordinating the performance of engineering and/or drafting work related to power generation systems, the engineering and/or drafting work being performed by a foreign supplier for a domestic company, the method comprising:
receiving a first request for a first user interface display page from a first user computer, the first user computer being located at the domestic company;
in response to the received first request, providing the first user interface display page to the first user computer, the first user interface display page being configured to receive information related to a work package document, the work package document being usable for coordinating the performance of the engineering and/or drafting work;
receiving the work package document information from the first user computer;
storing the received work package document information in a database;
receiving a second request for a second display page from a second user computer, the second user computer being located at the foreign supplier; and
in response to the received second request,
retrieving at least a first portion of the stored work package document information from the database;
generating the second display page, the second display page containing at least a second portion of the retrieved work package document information; and
providing the second display page to the second user computer.

47. The method of claim 46 wherein the work package document is a statement of work.

48. The method of claim 46 wherein the work package document is a purchase order.
